(19) United States
(12) Patent Application Publication
(10) Pub. No.: US 2009/0307011 A1
(43) Pub. Date: Dec. 10, 2009

(54) Method of adjusting an insurance premium

(75) Inventors: Michael J. Colson, East Amherst, NY (US); Stephen L. Coyle, Fairport, NY (US)

Correspondence Address: PHILLIPS LYTLE LLP;INTELLECTUAL PROPERTY GROUP, 3400 HSBC CENTER, BUFFALO, NY, 14203-3509, US

(73) Assignee: Computer Task Group, Inc.

(21) Appl. No.: 12/156,727

(22) Filed: Jun. 4, 2008

(51) Int. Cl. G06Q 40/00

(52) U.S. Cl. 705/4

(57) ABSTRACT

The present invention broadly provides an improved method (20) of adjusting, with the aid of a digital computer, an insurance premium charged by a payor to a customer so as to correlate more closely with the expected claims of that customer during a policy period. The improved method broadly includes the steps of: obtaining historical data, including the parameters of a past rate, of the customer (22); determining risk factors that influence or affect the insurance premium (23); creating an algorithm to adjust the insurance premium as a function of the risk factors (24); receiving a request for a rate adjustment (21); and calculating in the computer an adjustment to the premium as a function of the algorithm so as to increase the correlation between the premium to be charged and the expected claims of the customer during the policy period (26).

### TECHNICAL FIELD

The present invention relates generally to the field of insurance and underwriting, and, more particularly, to improved methods of adjusting, with the aid of a digital computer, the insurance premium charged by a payor to a customer so as to correlate more closely with the expected claims of that customer during a policy period.

### BACKGROUND ART

Insurance companies typically adjust their annual premiums to customers based on their own or another's past experience with those customers. However, this is not necessarily an accurate way upon which to calculate the current premium. For example, the claims paid during one reference year may be abnormally low. Hence, if a reduced premium is charged in the following year, and if the claims return to a normal level, then the insurance company may find that it has uncharged that particular customer.

Conversely, the reference year may be an abnormally high year in which more claims were made then would normally be encountered. Hence, the insurance payor may charge an increased premium in the following year because it expects the level of claims to be the same based on its experience in the preceding year. This can put the business relationship between the payor and the customer at risk, particularly if the customer attempts to secure coverage elsewhere at a lower premium.

There is a better and more accurate way of adjusting insurance premiums so that the amount of the premium will correspond more closely to the expected claims made.

Accordingly, it would be generally desirable to put this new plan into effect to be used to supplement existing rating schemes.

### DISCLOSURE OF THE INVENTION

With parenthetical reference to the corresponding parts, portions or surfaces of the disclosed embodiment, merely for purposes of illustration and not by way of limitation, the present invention broadly provides an improved method (20) of adjusting, with the aid of a digital computer, the insurance premium charged by a payor to a customer so as to correlate more closely with the expected claims of that customer during an upcoming policy period.

The improved method broadly includes the steps of: obtaining historical data, including the parameters of a past rate (or the past rate itself), of the customer (22); determining risk factors that influence or affect the insurance premium (23); creating an algorithm to adjust the insurance premium as a function of the risk factors (24); receiving a request for a rate adjustment (21); and calculating in the computer an adjustment to the premium as a function of the algorithm so as to increase the correlation between the premium to be charged and the expected claims of the customer during the policy period (26).

The policy of insurance may be health insurance.

The request for rate adjustment may be initiated by the payor.

The risk factors may be determined by determined by a consultant.

The algorithm may be created by the consultant.

The adjustment to the premium may be calculated by the consultant.

The risk factors for a prospective new customer of the payor may be different from the risk factors for a renewal customer of the payor.

The payor may not be obligated to charge such adjusted premium to the customer.

The customer may be one of a large number of customers of the payor.

The algorithm may be determined separately for each of the customers.

Accordingly, the general object of the invention is to provide an improved method of adjusting, with the aid of a digital computer, an insurance premium charged by a payor to a customer so as to correlate more closely with the expected claims of that customer during an upcoming policy period.

These and other objects and advantages will become apparent from the foregoing and ongoing written specification, the drawings and the appended claims.

### BRIEF DESCRIPTION OF THE DRAWINGS

FIG. 1 is a block diagram showing one way in which the improved method may be practiced.

### DISCLOSURE OF THE PREFERRED EMBODIMENTS

At the outset, it should be clearly understood that like reference numerals are intended to identify the same structural elements, portions or surfaces consistently throughout the several drawing figures, as such elements, portions or surfaces may be further described or explained by the entire written specification, of which this detailed description is an integral part. Unless otherwise indicated, the drawings are intended to be read (e.g., cross-hatching, arrangement of parts, proportion, degree, etc.) together with the specification, and are to be considered a portion of the entire written description of this invention. As used in the following description, the terms “horizontal”, “vertical”, “left”, “right”, “up” and “down”, as well as adjectival and adverbial derivatives thereof (e.g., “horizontally”, “rightwardly”, “upwardly”, etc.), simply refer to the orientation of the illustrated structure as the particular drawing figure faces the reader. Similarly, the terms “inwardly” and “outwardly” generally refer to the orientation of a surface relative to its axis of elongation, or axis of rotation, as appropriate.

There may be three parties to an insurance adjustment. The “payor” is the party who has issued the insurance, and who will pay any claims. In the health care field, this may be an entity such as Blue Cross-Blue Shield, Independent Health, or the like. The “customer” is typically a business that contracts with the payor to provide insurance coverage for its employees. These customers may be in different industries, and have different experience factors with respect to claims made. As used herein, a “consultant” may be a third party who contracts with the payor to provide certain services to the payor, based on data that the payor provides to the consultant about its various customers. The consultant may be an entity separate from the payor, or may be a sibling operation, or an office or section within the payor.

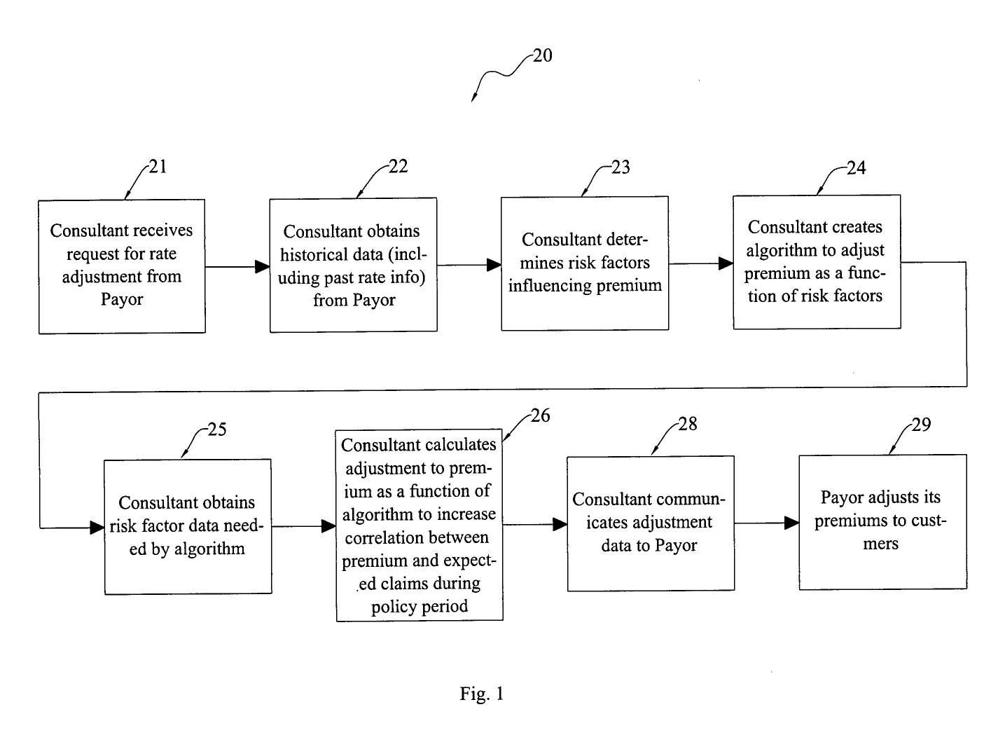

Referring now to the drawing, FIG. 1 depicts one way in which the improved method may be implemented. The improved method is generally indicated at 20, and is shown as comprising a series of operative steps. The steps shown in the drawing will now be described, but the order of these steps is not deemed to be particularly critical unless a specific claim to that effect is expressly set forth.

Referring to the drawing, in box 21, the consultant receives a request for rate adjustment from the payor.

The consultant then obtains historical data, including past rate information or the parameters of same, from the payor, as indicated in box 22.

The consultant then determines the various risk factors influencing the premium, as indicated in box 23.

The consultant then creates an algorithm to adjust the premium as a function of the risk factors, as indicated in box 24. The premium to be adjusted may be a past premium or a tentative or initially-calculated premium that may be in need of further adjustment.

The consultant then obtains risk factor data needed by the algorithm. This typically comes from external sources. The step is indicated in box 25.

The consultant then calculates an adjustment to the premium to be charged to each customer as a function of the algorithm to increase the correlation between the premium to be charged to that customer and the expected claims likely to be made by that customer during the policy period, as indicated in box 26.

As indicated in box 28, the consultant then communicates the adjustment data for each customer to the payor, who then adjusts his premium in accordance with such data, as indicated in box 29.

These various steps need not necessarily be performed in the order depicted in FIG. 1. For example, the consultant could obtain historical data from the payor, and/or determine the risk factors and/or create the algorithm, and/or obtain the risk factor data prior to the time the payor specifically requests a rate adjustment from the consultant. Indeed, this request could come at any time.

The historical data is typically demographic data on the various customers, such as the group number, employee number, past experience, number of claims paid during a particular period, the number of eligibles, the number of contracts, whether an HMO, PPO, or the like, whether a new or renewal customer, as well as the name and address of each customer.

The data obtained by the consultant may include data concerning the viability of the customer's business, and the customer's experience in paying its bills. However, these are only two examples of various risk factors.

Therefore, the present invention broadly provides an improved method of adjusting an insurance premium charged by a payor to a customer with the aid of a digital computer so as to correlate more closely with the expected claims of that customer during a policy period. The improved method includes the steps of obtaining historical data, including the parameters of a past rate, of the customer; determining risk factors that influence the insurance premium; creating an algorithm to adjust the insurance premium as a function of the risk factors; receiving a request for a rate adjustment; and calculating in the computer an adjustment to the premium to be charged to each customer of the payor as a function of the algorithm so as to increase the correlation between the premium charged to that customer and the expected claims of that customer during the policy period. The insurance policy may be health insurance, although the principles apply to other types of insurance as well. The various risk factors, algorithm and adjustment to the premium, may be performed by the consultant. However, they may also be performed directly by the payor in some cases.

The payor is not necessarily obligated to amend or adjust its policy in the light of the data provided by the consultant, but it may do so if desired.

Therefore, while the presently-preferred form of the improved method has been shown and described, and several modifications and changes thereof discussed, persons skilled in this art will readily appreciate that various additional changes and modifications may be made without departing from the spirit of the invention, as defined and differentiated by the following claims.

What is claimed is:

1. The method of adjusting an insurance premium charged by a payor to a customer with the aid of a digital computer so as to correlate more closely with the expected claims of that customer during a policy period, comprising the steps of:
obtaining historical data, including the parameters of a past rate, of said customer;
determining risk factors that influence said insurance premium;
creating an algorithm to adjust said insurance premium as a function of said risk factors;
receiving a request for a rate adjustment; and
calculating in said computer an adjustment to said premium as a function of said algorithm so as to increase the correlation between said premium and the expected claims of said customer during said policy period.

2. The method as set forth in claim 1, wherein such policy of insurance is health insurance.

3. The method as set forth in claim 1, wherein said request for rate adjustment is provided by said payor.

4. The method as set forth in claim 1, and wherein said risk factors are determined by a consultant.

5. The method as set forth in claim 4, wherein said algorithm is created by said consultant.

6. The method as set forth in claim 4 wherein said adjustment to said premium is calculated by said consultant.

7. The method as set forth in claim 1 wherein the risk factors for a prospective new customer of said payor are different from the risk factors of a renewal customer of said payor.

8. The method as set forth in claim 1 wherein said payor is not obligated to charge such adjusted premium to said customer.

9. The method as set forth in claim 1 wherein said customer is one of a large number of customers of said payor.

10. The method as set forth in claim 9 wherein said algorithm is determined separately for each of said customers.
